(19) United States
(12) Patent Application Publication
(10) Pub. No.: US 2006/0039284 A1
(43) Pub. Date: Feb. 23, 2006

(54) Method and apparatus for processing a complete burst of data

(75) Inventors: Shubing Zhai, Shanghai (CN); Yefei Sun, Shanghai (CN); Xiaoqian Zhang, Shanghai (CN); Zhonghai Gan, Shanghai (CN)

Correspondence Address: HEIMLICH LAW, 5952 DIAL WAY, SAN JOSE, CA, 95129, US

(73) Assignee: Integrated Device Technology, Inc., Santa Clara, CA (US)

(21) Appl. No.: 11/102,996

(22) Filed: Apr. 11, 2005

Related U.S. Application Data
(60) Provisional application No. 60/561,774, filed on Apr. 12, 2004.

(51) Int. Cl. H04J 1/16

(52) U.S. Cl. 370/235

(57) ABSTRACT

Disclosed are a method and apparatus for processing a complete burst of data by receiving said complete burst of data, storing the complete burst of data in a memory, associating the complete burst of data with a first logical channel and dispatching an egress burst of data according to one or more complete bursts of data stored in a memory and associated with the first logical channel.

### RELATED APPLICATION

This patent application claims priority of U.S. Application Ser. No. 60/561,774 filed on Apr. 12, 2004, entitled “Method And Apparatus For Forwarding Bursty Data”, which is by the same inventors as this application and which is hereby incorporated herein by reference. This patent application claims priority of U.S. application Ser. No. 10/861,879 filed on Jun. 4, 2004, entitled “Method And Apparatus For Forwarding Bursty Data”, which is by the same inventors as this application and which is hereby incorporated herein by reference.

### FIELD OF THE INVENTION

The present invention pertains to communicating data. More particularly, the present invention relates to a method and apparatus for processing a complete burst of data bursty data.

### BACKGROUND OF THE INVENTION

A wide variety of electronic communication systems utilize an interface known as a “bursty interface”. A bursty interface is an interface that is generally capable of sending or receiving some amount of data on a periodic basis. During a first interval in such a period, data is usually sent or received at a high data rate. During a second interval within the same period, the interface is generally quiescent, i.e. the interface is not sending or receiving data during this second interval.

Bursty interfaces are commonly used because of the bursty nature of data communicated from one system to another. Bursty interfaces are also commonly used as a mechanism for decoupling the physical sampling of data between two systems that are communicatively coupled to each other. In digital systems, for example, two independent systems are generally operated using two independent clocks. A bursty interface is a practical means to enable the transfer of data between two separately clocked systems because a bursty interface generally provides an elasticity buffering capability.

In the past, a bursty interface was generally designed around a linear memory known as a “first-in-first-out” (FIFO) memory. A FIFO memory generally provides an input port and an output port. In many implementations, the input port and the output port can be independently clocked. For example, an independent clocking mechanism is generally provided for a FIFO input port. Using this independent clocking mechanism, data can be stored in the FIFO memory without regard to any clocking mechanism used to retrieve data from the FIFO. It generally follows that a FIFO memory provides a separate and independent clocking mechanism for data retrieval. The retrieval clocking mechanism can be used without regard to the clock mechanism used to store data in the FIFO memory. This type of structure can be used to support a simplistic mechanism for decoupling the clock signals of two independent data systems.

In a bursty interface, the input port of a FIFO has traditionally been used to receive data during a first interval by means of an input clocking mechanism. The output port of the FIFO can then be used to retrieve data using an independent retrieval clocking mechanism. The retrieval clocking mechanism is also generally used as a basis for manipulating data within the system receiving bursty data. As such, the retrieval clocking mechanism can be considered the operating clock that synchronizes the internal operation of the system receiving such bursty data. Data can then be retrieved from the output port of the FIFO at some convenient rate commensurate with the operation of the system receiving the bursty data. Bursty data can then be stored in the FIFO as it arrives at an independent rate from another system.

Modern computer networking systems are also employing bursty interface structures. For example, one common computer networking system known as System Packet Interface (SPI) comprises a specific implementation of a bursty interface that can be used to transfer data packets from one system element to another. The SPI interface has been defined at various levels (e.g. SPI-3 and SPI-4). SPI-3 and SPIA define various aspects of the System Packet Interface including but not limited to transfer speed, packet sizing and burst sizing. One interesting characteristic in any bursty interface used to carry data packets is that of packet alignment relative to a data burst. For example, a data burst may be used to carry a complete single packet, a portion of a single packet, a complete single packet and a portion of a second packet, two or more complete data packets and portions of two or more data packets. Alignment of a data packet to a data burst is a common issue irrespective of the type of bursty interface used to communicate a data packet from one system to another.

Although a FIFO is a useful building block in the design and implementation of a bursty interface, there are several problems that surface when a bursty interface is used to convey a data packet. One specific problem is that of flow control. When a bursty interface is based on a FIFO, flow control is generally designed to reflect the availability of memory within the FIFO. For example, when a FIFO is filled to a certain capacity, the FIFO may not be able to reliably receive an entire burst of data. Accordingly, a system that is delivering bursty data to a receiving system is directed to hold additional data transfers until the receiving system can retrieve some of the data stored in the FIFO. As the receiving system retrieves data stored in the FIFO, the hold directive can be suspended once the FIFO can again reliably accommodate an additional burst of data. Although such flow control can be used to manage a FIFO-based bursty interface, it is simply not suitable when the data carried by a data burst is packetized. This is because a hold directive can be issued during a data burst, preventing the reception of an entire data burst within a given period of time. If the FIFO cannot reliably accommodate an entire data burst, a receiving system may not be able to properly process a data packet if the data packet is only partially received by the FIFO. This is especially problematic in the event that a data packet needs to be forwarded to another system using a second bursty interface.

### BRIEF DESCRIPTION OF THE DRAWINGS

Several alternative embodiments will hereinafter be described in conjunction with the appended drawings and figures, wherein like numerals denote like elements, and in which:

FIG. 1 is a flow diagram that depicts one example method for processing a complete burst of data;

FIG. 2 is a flow diagram that depicts one alternative example method for storing a complete burst of data in a memory so long as memory is available;

FIG. 3 is a flow diagram that depicts one illustrative method for storing a complete burst of data in a segmented memory;

FIG. 4 is a flow diagram that depicts one example method for allocating a first segment of memory;

FIG. 5 is a flow diagram that depicts one illustrative method for storing a complete burst of data while minimizing fragmentation of a memory resource;

FIG. 6 is a flow diagram that depicts one alternative example method for managing an incoming data burst according to a logical channel;

FIG. 7 is a flow diagram that depicts one alternative example method for dispatching an egress burst of data according to a forward back pressure signal;

FIG. 8 is a flow diagram that depicts one alternative example method for dispatching an egress burst of data that includes a portion of a complete burst of incoming data;

FIG. 9 is a flow diagram that depicts one alternative example method for dispatching an egress burst of data that includes a complete burst of incoming data;

FIG. 10 is a flow diagram that depicts one alternative example method for dispatching an egress burst of data that is formed from more than one ingress complete data burst;

FIG. 11 is a block diagram of one example embodiment of system for processing a complete burst of ingress data;

FIG. 12 is a data flow diagram that depicts the internal operation of alternative example embodiments of a system for processing a complete burst of data;

FIG. 13 is a block diagram that depicts one example embodiment of a burst data interface controller; and

FIG. 14 is a block diagram that depicts alternative example embodiments of a memory control unit.

### DETAILED DESCRIPTION

Bursty interfaces are often used to receive packetized data. One example of a packetized data interface is the System Packet Interface (SPI). The SPI interface is primarily defined in two documents including:
SPI-3 (OC-48 System Packet Interface) OIF-SPI3-01.0—SPI-3 Packet Interface for Physical and Link Layers for OC-48. OIF June 2000; and
SPI-4 phase 2 (OC-192 System Packet Interface) OIF-SPI4-02.0—System Packet Interface Level 4 (SPI-4) Phase 2: OC-192 System Interface for Physical and Link Layer Devices. OIF January 2001.

Although the present method and apparatus can be used to process packetized data bursts that conform to the SPI specification, the claims appended hereto are not intended to be limited in scope to such applications and the present method and apparatus can be applied in any application where bursty data from one system is received in another system.

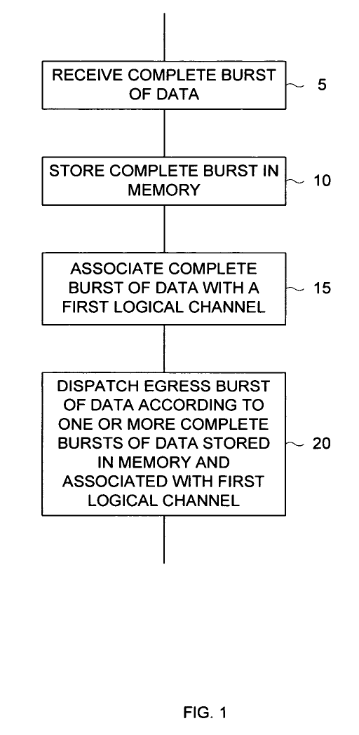

FIG. 1 is a flow diagram that depicts one example method for processing a complete burst of data. According to this example method, a burst of data is processed by receiving a complete burst of data (step 5) and storing the complete burst in a memory (step 10). The complete burst of data that is received into the memory is then associated with a first logical channel (step 15). An egress burst of data is then dispatch according to one or more complete bursts of data that are stored in the memory and associated with the first logical channel (step 20). It can be appreciated that the present method provides for storing a complete burst of data in a memory as a complete data unit. This complete data unit, or quantum of data is then associated with a first logical channel. It should further be appreciated that an additional complete burst of data is, according to one illustrative variation of the present method, also associated with the first logical channel. By storing a complete burst of data in the memory, a complete burst of data can be received so long as additional memory is available. Also, a complete burst of data is only logically associated with a first logical channel. This provides for flexible utilization of available memory when compared to fixed memory assets used to receive a burst of data for a particular logical channel.

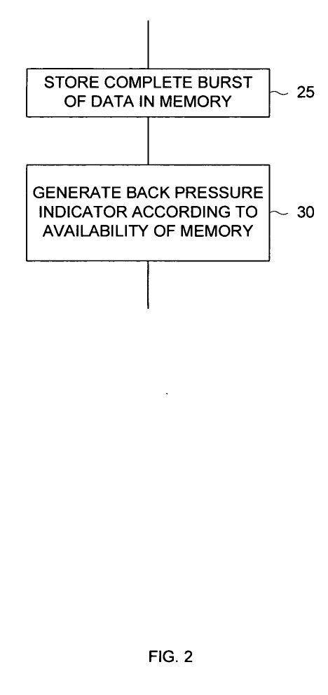

FIG. 2 is a flow diagram that depicts one alternative example method for storing a complete burst of data in a memory so long as memory is available. According to this alternative example variation of the present method, a complete burst of data is stored in the memory (step 25). In the event that memory utilization does not provide for receiving an additional complete burst of data, a back pressure indicator is then generated (step 30). The back pressure indicator, according to one illustrative use case, is used to prevent a data source from dispatching an additional burst of data. Hence, incoming data can be throttled when memory resources fall below acceptable limits.

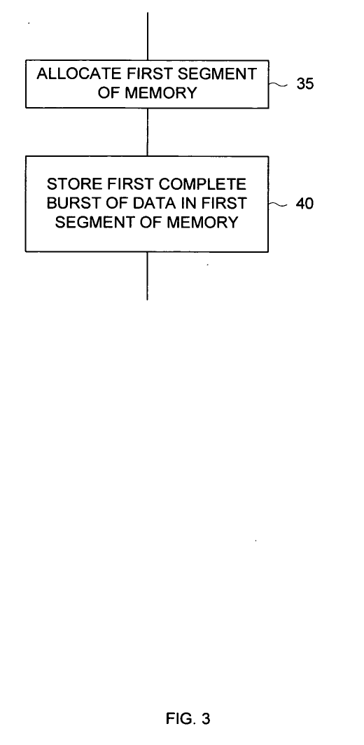

FIG. 3 is a flow diagram that depicts one illustrative method for storing a complete burst of data in a segmented memory. It should be appreciated that a contiguous memory resource can be used to store a burst of data received according to various illustrative methods herein described. In one variation of the present method, such a memory is segmented in order to provide efficient mapping of a memory resource to a particular logical channel. For example, by allocating a first segment in the memory (step 35) to a logical channel, a first complete burst of data is stored in the first segment of memory (step 40). It should likewise be appreciated that the first segment of memory is typically allocated in a manner so as to enable efficient egress of data from the memory, also according to a logical channel. It should likewise be appreciated that such segmentation, according to one example variation of the present method, is accomplished according to at least one of storage and egress requirements for a particular logical channel.

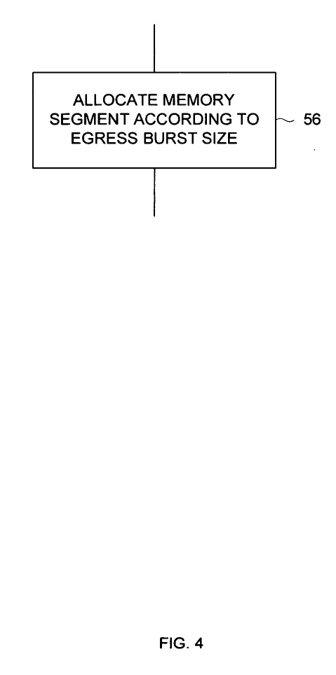

FIG. 4 is a flow diagram that depicts one example method for allocating a first segment of memory. According to this example method, a first segment of memory is allocated by allocating a quantum of memory according to an egress burst size. As already described, allocating a first segment of memory, according to one variation of the present method, is accomplished in order to enable efficient egress of data from the memory. According to this illustrative variation of the present method, the size of a first segment of memory is selected according to an anticipated size of a burst of egress data. In yet another example variation of the present method, the size of a first segment of memory is selected according to a minimum elasticity value attributed to a particular logical channel. For example, a logical channel may need to buffer a prescribed quantity of ingress data bursts before an egress data burst is dispatched. This technique is especially useful in situations where a bridge must be formed from one networking structure to another and wherein an intrinsic size of a burst of data received from a source data network is some fraction of an intrinsic size of a burst of data delivered to a destination data network.

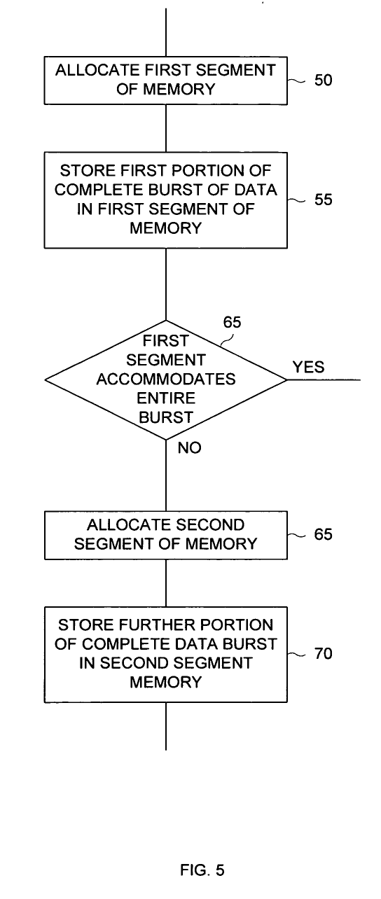

FIG. 5 is a flow diagram that depicts one illustrative method for storing a complete burst of data while minimizing fragmentation of a memory resource. It should be appreciated that a memory resource, once partitioned, may become fragmented when a complete burst of data does not fill an entire allocated memory segment. When a complete burst of data does not fill an entire allocated memory segment, the remainder of the memory segment is essentially wasted. In order to alleviate such memory fragmentation, one alternative variation of the present method provides for minimizing the size of a memory segment so as to accommodate an average size of a complete burst of incoming data. Accordingly, a first segment of memory is allocated (step 50) and a first portion of a complete burst of data is then stored in the first segment of memory so allocated (step 55). In the event that the first allocated segment of memory cannot accommodate an entire complete burst of data (step 60), a second segment of memory is allocated (step 65) and any further portion of the complete data burst is then stored in the second allocated segment of memory (step 70). In this manner, a memory resource is segmented into smaller segments which can be dynamically allocated to accommodate a complete burst of data on an “as needed” basis.

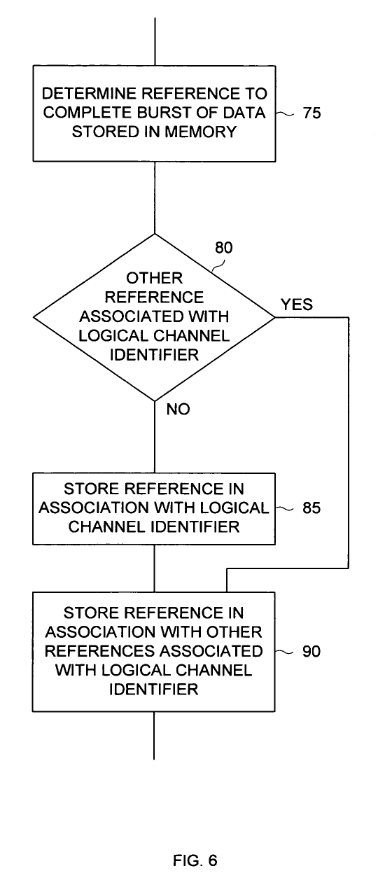

FIG. 6 is a flow diagram that depicts one alternative example method for managing an incoming data burst according to a logical channel. According to this example method, complete burst of data is associated with a first logical channel by determining a reference to a complete burst of data stored in memory (step 75). The reference, according to yet another variation of the present method, comprises a pointer to a data structure that is stored in a memory, wherein the data structure is used to store an incoming burst of data. Once a reference to a complete burst of data is determined, the reference is stored in association with a logical channel identifier (step 85) when other references have not yet been associated with that logical channel identifier (step 80). In the case where a logical channel identifier has already been associated with a reference to an incoming burst of data (step 80), the reference to a complete burst of data stored in the memory is stored in association with the other references and also in association with the logical channel identifier (step 90).

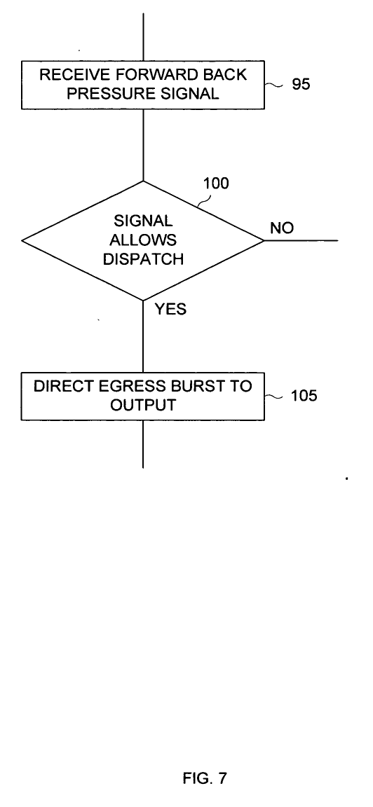

FIG. 7 is a flow diagram that depicts one alternative example method for dispatching an egress burst of data according to a forward back pressure signal. According to this alternative example method, a forward back pressure signal is received (step 95). The forward back pressure signal is typically received from a destination device and is indicative of the ability of the destination device to receive a complete burst of data. When the forward back pressure signal indicates that the destination device is able to receive a complete burst of data (step 100), a complete egress burst of data is then directed to an output device (step 105). In this manner, the destination device is able to throttle the arrival of a complete burst of data.

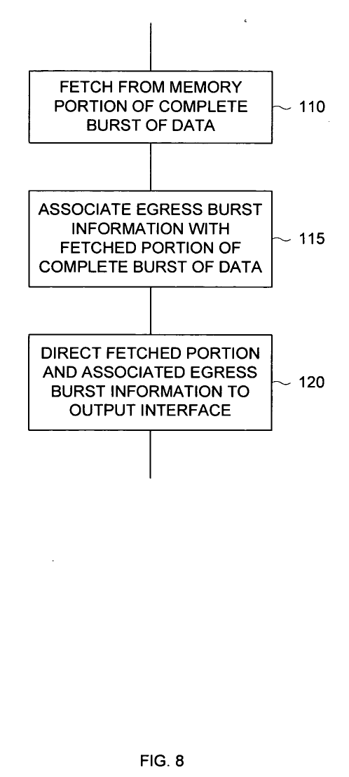

FIG. 8 is a flow diagram that depicts one alternative example method for dispatching an egress burst of data that includes a portion of a complete burst of incoming data. It should be appreciated that, according to this alternative example method, a portion of a complete burst of data is dispatched from a memory resource (step 110). The portion of a complete burst of data is then associated with egress burst information (step 115). The fetched portion of a complete burst of data and the associated egress burst information is then directed to an output interface (step 120). This particular variation of the present method is typically applied in a situation where an intrinsic size of a complete burst of data carried by a destination network is smaller than an intrinsic size of a complete burst of data carried by a source network. Accordingly, this alternative variation of the present method is well-suited in applications where a bridge must be formed between a source network and a destination network that rely on dissimilar sizes of a complete burst of data. It should be appreciated that a portion of a complete burst of data is retrieved from the memory according to an association with a logical channel.

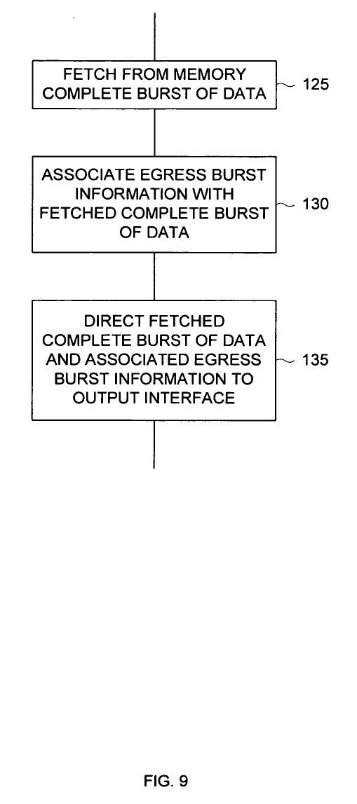

FIG. 9 is a flow diagram that depicts one alternative example method for dispatching an egress burst of data that includes a complete burst of incoming data. It should be appreciated that, according to one illustrative use case, this alternative variation of the present method provides for establishing a bridge between a source network and a destination network that rely on substantially equivalent sized bursts of data. Accordingly, this variation of the present method provides for fetching a complete burst of data from a memory resource (step 125). Egress burst information is then associated with the fetched complete burst of data (step 130). The complete burst of data is then directed to an output interface along with the associated egress burst information (step 135). It should be appreciated that a complete burst of data is retrieved from the memory according to an association with a logical channel.

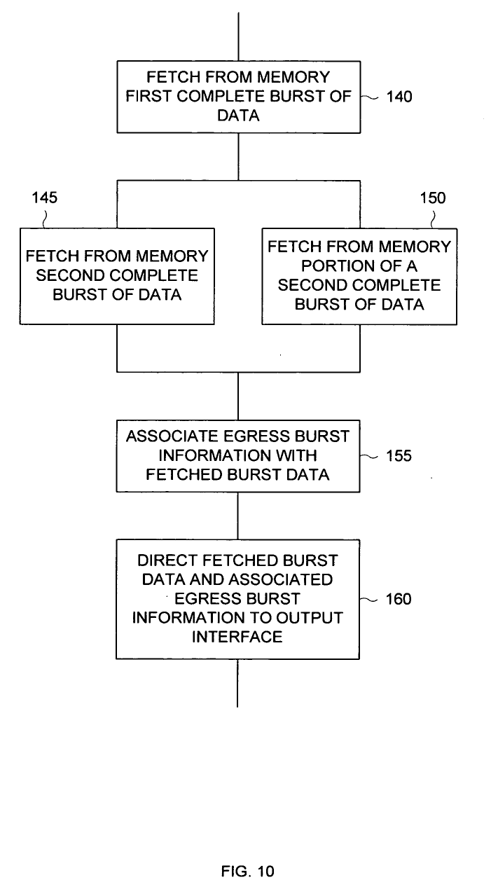

FIG. 10 is a flow diagram that depicts one alternative example method for dispatching an egress burst of data that is formed from more than one ingress complete data burst. According to this alternative example method, a first complete ingress data burst is fetched from a memory (step 140). Then, according to one variation of the present method, a second complete burst of ingress data is fetched from the memory (step 145). According to yet another variation of the present method, a portion of a second burst of ingress data fetched from the memory (step 150). It should be appreciated that, according to one illustrative use case, a destination network will carry a burst of data that has an intrinsic size that is greater than the intrinsic size of a burst of data received from a source network. Egress burst information, according to one variation of the present method, is associated with the first complete burst of data and at least one of a second complete burst of data and a portion of a second complete burst of data, all of which are retrieved from a memory. The fetched first complete burst of data, at least one of a second complete burst of data and a portion of a second burst of data and the egress burst information are then directed to an output interface (step 160). It should be appreciated that any one of a first complete burst of data, a second complete burst of data and a portion of a second complete burst of data are retrieved from the memory according to an association with a logical channel.

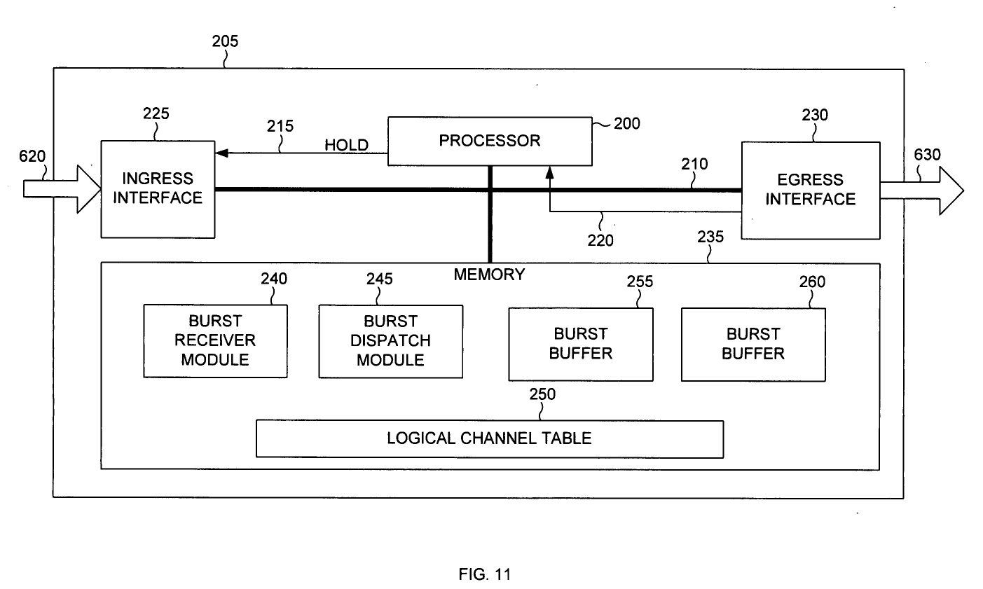

FIG. 11 is a block diagram of one example embodiment of system for processing a complete burst of ingress data. According to one alternative example embodiment, a system 205 for processing an ingress burst of data comprises a processor 200, an ingress interface 225, an egress interface 230 and a memory 235. In one example embodiment the ingress interface 225 receives data from a source 620, and the egress interface 230 provides output to a destination 630. In one embodiment the ingress interface 225, the egress interface 230, the memory 235, and the processor 200 communicate over a bus 210. In one embodiment the processor 200 is capable of generating a hold signal 215 going to the ingress interface 225, and the processor 200 is capable of receiving a status signal 220 from the egress interface 230.

Also included in various example alternative embodiments of the system 205 are one or more functional modules. A functional module is typically embodied as an instruction sequence. An instruction sequence that implements a functional module, according to one alternative embodiment, is stored in the memory 235. The reader is advised that the term “minimally causes the processor” and variants thereof is intended to serve as an open-ended enumeration of functions performed by the processor 200 as it executes a particular functional module (i.e. instruction sequence). As such, an embodiment where a particular functional module causes the processor 200 to perform functions in addition to those defined in the appended claims is to be included in the scope of the claims appended hereto. This example embodiment further includes a burst receiver module 240 and a burst dispatch module 245, both of which are stored in the memory 235. In yet another alternative example embodiment, the memory 235 is also use to store one or more logical channel tables 250. In yet another alternative example embodiment, the memory 235 is used to store one or more burst buffers (255,260), which are logically equivalent to a memory segment described supra.

The functional modules (i.e. their corresponding instruction sequences) described thus far that enable processing of a burst of data according to the present method are, according to one alternative embodiment, imparted onto computer readable medium. Examples of such medium include, but are not limited to, random access memory, read-only memory (ROM), compact disk ROM (CD ROM), floppy disks, hard disk drives, magnetic tape and digital versatile disks (DVD). Such computer readable medium, which alone or in combination can constitute a stand-alone product, can be used to convert a general-purpose computing platform into a device capable of processing a burst of data according to the techniques and teachings presented herein. Accordingly, the claims appended hereto are to include such computer readable medium imparted with such instruction sequences that enable execution of the present method and all of the teachings herein described.

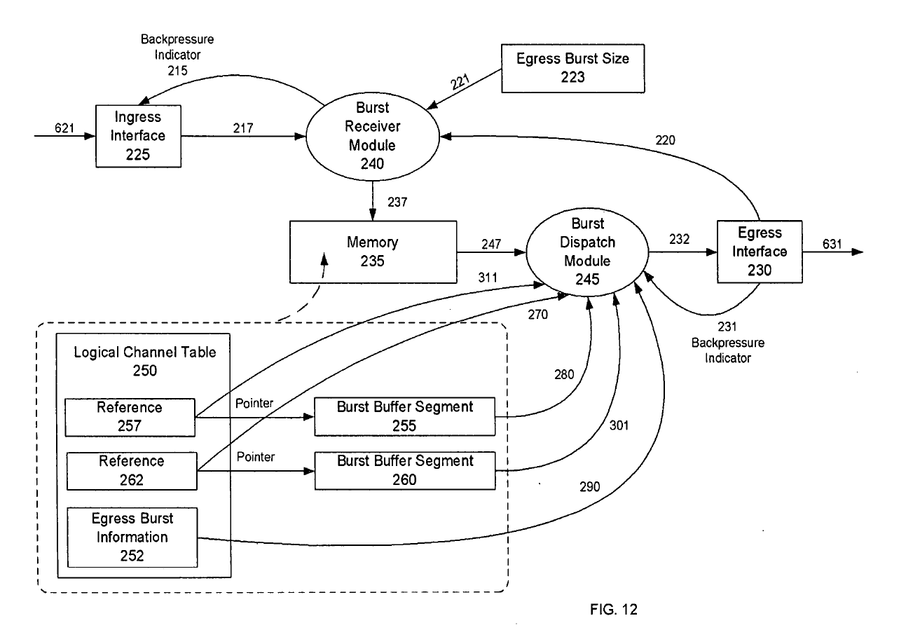

FIG. 12 is a data flow diagram that depicts the internal operation of alternative example embodiments of a system for processing a complete burst of data. In operation, the processor 200 executes the burst receiver module 240. The burst receiver module 240, when executed by the processor, minimally causes the processor 200 to receive 217 a complete burst of data from the ingress interface 225. The burst receiver module 240 further minimally causes the processor to store 237 a complete burst of data in the memory 235. It should be appreciated that the processor 200 stores the complete burst of data in association with a logical channel. In one alternative example embodiment, this is accomplished by storing either of a portion of a complete burst of data or a complete burst of data in a burst buffer (255, 260) which are referenced by pointers (257, 262). The pointers are stored in a logical channel table 250 in order to associate one or more burst buffers with a particular logical channel. In one alternative example embodiment, the logical channel table 250 further includes an egress burst information packet 252, the use of which is described infra.

Once a complete burst of data stored is stored in the memory 235, the processor 200 then executes the burst dispatch module 245. When executed by the processor, the burst dispatch module 245 minimally causes the processor to retrieve 247 from the memory 235 one or more complete bursts of data. The burst dispatch module 245 then minimally causes the processor to generate an egress burst according to the one or more bursts of data retrieved 247 from the memory. The egress burst of data is then directed 232 to the egress interface 230.

In one alternative example embodiment, the burst receiver module 240 causes the processor 200 to monitor the availability of memory 235 and also further minimally causes the processor to generate a backpressure indicator 215 when the amount of available memory falls below a pre-established threshold. The back pressure indicator 215 is directed to the ingress interface 225, which causes a source of a burst of data to throttle delivery of said burst of data.

In yet another alternative example embodiment, the burst receiver module 240 causes the processor 200 to store a complete burst of data in the memory 235 by minimally causing the processor to allocate a first segment in the memory and then store a first complete burst of data in the allocated first segment. It should be appreciated that a first segment is also referred to as a burst buffer 255.

In yet another example alternative embodiment, the burst receiver module 240 causes the processor 200 to store a complete burst of data in the memory 235 by minimally causing the processor 200 to allocate a first segment in the memory, store a first portion of the complete burst of data in the first allocated segment, allocate a second segment (such as a second burst buffer 260) and then store a further portion of the complete burst of data in the second segment commensurate with the teachings of the present method.

In one alternative example embodiment, the burst receiver module 200 causes the processor 200 to store a complete burst of data in the memory by creating a reference to a burst buffer (255, 260) and then storing the reference (257, 262) in a logical channel table 250, which is stored in the memory 235. It should be appreciated that the logical channel table 250 is organized as a chain of references to individual burst buffers (i.e. memory segments) stored in the memory 235. According to one alternative example embodiment, the logical channel table 250 is also used to store egress burst information 252. This egress burst information 252 is typically associated with an egress data burst, which is generated by the processor 200 as it continues to execute the burst dispatch module 245.

According to one alternative example embodiment, the burst dispatch module 245, when executed by the processor 200, causes the processor to dispatch an egress burst of data by minimally causing the processor 200 to receive a back pressure indicator 231 from the egress interface 230. The burst dispatch module 245 further minimally causes the processor 200 to direct 232 to the egress interface 230 an egress burst of data retrieved 247 from the memory 235. This alternative example embodiment of a burst dispatch module 245 causes the processor 200 to direct 232 the egress burst of data to the egress interface 230 when the back pressure indicator 231 indicates that the egress interface 230 can receive a complete burst of egress data.

In yet another alternative example embodiment, the burst dispatch module 245 causes the processor 200 to dispatch an egress burst of data by minimally causing the processor 200 to retrieve egress burst information from the memory 235. In one alternative example embodiment, the burst dispatch module 245 causes the processor 200 to retrieve egress burst information from a logical channel table 250 that includes such egress burst information 252. This example embodiment of a burst dispatch module 245 further minimally causes the processor to retrieve from the memory 235 a portion of a complete burst of data. According to one alternative example embodiment, the burst dispatch module 245 causes the processor 200 to retrieve a portion of a complete burst of data by retrieving a reference (257, 262) from a logical channel table 250. The processor 200 then uses a retrieved reference (i.e. a pointer) to access a burst buffer 255 (i.e. a segment of memory) from whence a portion of a complete burst of data is retrieved.

According to yet another alternative example embodiment, the burst dispatch module 245 causes the processor 200 to dispatch an egress burst of data by minimally causing the processor 200 to retrieve egress burst information from the memory 235. As heretofore described, one alternative example embodiment of a burst dispatch module 245 causes the processor 200 to retrieve egress burst information from a logical channel table 250, which includes egress burst information 252 stored therein. According to this alternative example embodiment, the burst dispatch module 245 causes the processor 200 to then retrieve from the memory 235 a complete burst of data. In one alternative example embodiment, the burst dispatch module 245 causes the processor to retrieve a complete burst of data from the memory 235 by minimally causing the processor 200 to retrieve a reference (257, 262) from the logical channel table 250. The processor 200 then uses a retrieved reference (257, 262) to access a burst buffer (255, 260) which is also stored in memory and used to store a complete burst of ingress data.

In one additional example alternative embodiment, the burst dispatch module 245 causes the processor to dispatch an egress burst of data by minimally causing the processor 200 to retrieve egress burst information from the memory 235, which according to one alternative embodiment is retrieved from a logical channel table 250 that includes such egress burst information 252. The burst dispatch module 245 further minimally causes the processor to retrieved 247 from the memory 235 a first complete burst of data and at least one of a second complete burst of data and a portion of a second complete burst of data. It should be appreciated that, according to yet another alternative example embodiment, the burst dispatch module 245 minimally causes the processor to retrieve data from the memory by means of a reference (257, 262) which is stored in a logical channel table 250.

In yet another example embodiment, the ingress interface 225 receives an input from a source such as 621, and the egress interface 230 provides an output to a destination such as 631. Burst receiver module 240 may receive information 221 on egress burst size 223 and is capable of receiving a status signal 220 from the egress interface 230.

In all of these example alternative embodiment, the burst dispatch module 245 causes the processor 200 to generate an egress burst of data according to egress burst information retrieved 247 from the memory 235 and also according to at least one of a portion of a complete burst of data, a complete burst of data, a complete burst of data augmented with at least one of a portion of a second burst of data or a complete second burst of data. The egress burst of data generated by the processor as it executes the burst dispatch module 245 is then conveyed to 232 to the egress interface 230.

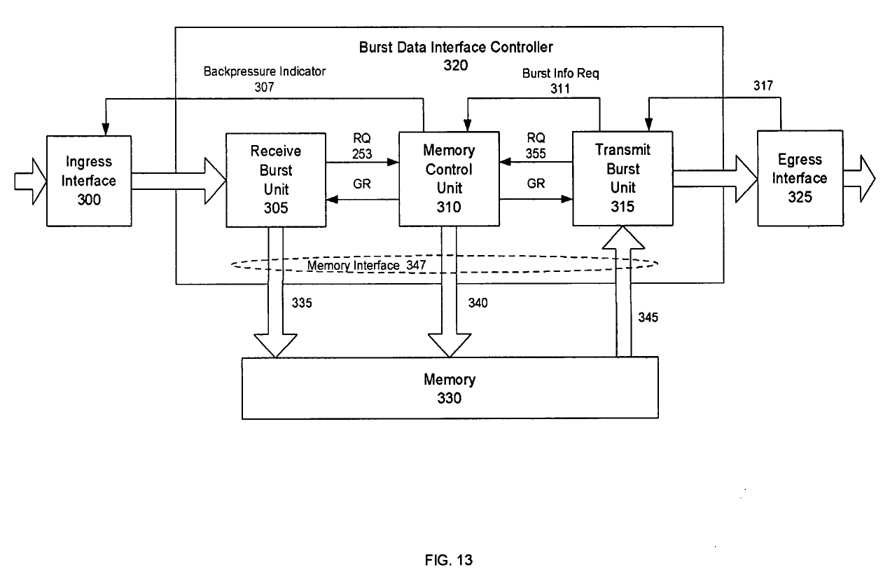

FIG. 13 is a block diagram that depicts one example embodiment of a burst data interface controller. According to this example embodiment, a burst data interface controller 320 comprises a memory interface 347, a memory control unit 310, a receive burst unit 305 and a transmit burst unit 315. The receive burst unit 305 is capable of receiving a complete burst of data from an ingress interface 300. In this alternative example embodiment, the receive burst unit 305 directs a complete burst of data to a memory 330 by means of a memory write interface 335, which is included in the memory interface 347. The memory control unit 310 enables the receive burst unit 305 to store a complete burst of data in the memory 330 according to a memory address 340 generated by the memory control unit 310. It should be appreciated that the memory control unit 310 generates a memory address 340 for a particular complete burst of data by associating the complete burst of data with a logical channel.

The transmit burst unit 315 retrieves one or more bursts of data from a memory 330, again according to a logical channel association, by using a memory address provided by the memory control unit 310. The transmit burst unit 315 retrieves burst data using a read interface 345 that is included in the memory interface 347 provided by the burst data interface controller 320. The transmit burst unit 315 then directs burst data to an egress interface 325.

In an alternative example embodiment, the memory control unit 310 monitors the availability of memory in an external memory resource 330. Based on the availability of memory, the memory control unit 310 generates a back pressure indicator 307. The back pressure indicator 307, when active, indicates that the memory 330 can not accommodate a complete burst of ingress data. Accordingly, the back pressure indicator 307 can be used by an ingress interface 300 in order to throttle the delivery of a complete burst of data to the burst data interface controller 320.

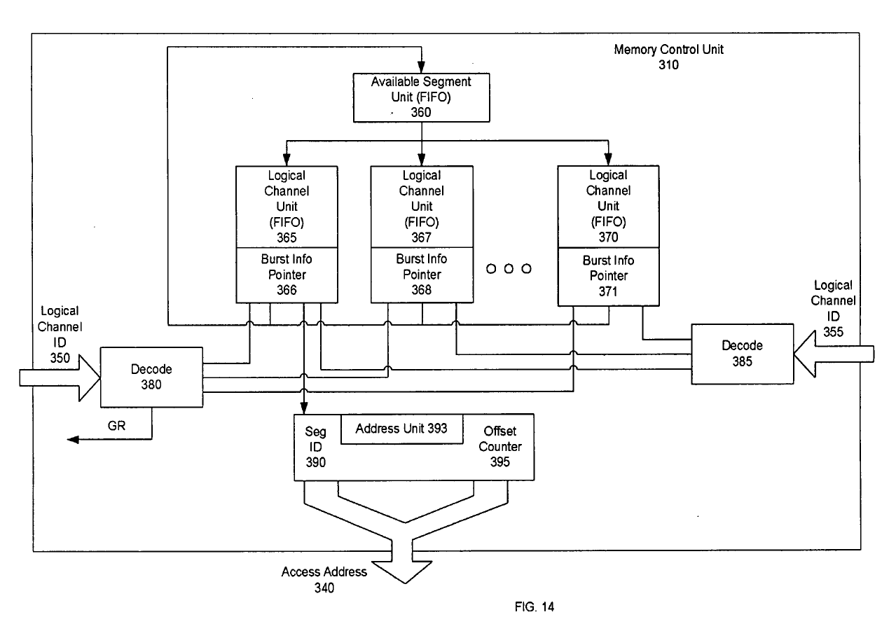

FIG. 14 is a block diagram that depicts alternative example embodiments of a memory control unit. According to one alternative example embodiment, a memory control unit 310 includes an available segment unit 360. The available segment unit 360, according to one alternative example embodiment, is used to store one or more memory segment references. In operation, the available segment unit 360 provides a reference to an available memory segment. The segment reference provided by the available segment unit 360 is directed to one out of one or more logical channel units (365,367,370). It should be appreciated that any number of logical channel units can be included in the memory control unit 310. Any example of a particular quantity of logical channel units included in a memory control unit are presented herein for illustration purposes only and are not intended to limit the scope of the claims appended hereto. In yet another alternative example embodiment, the available segment unit 360 stores one or more segment references that are sized according to an egress burst size, as discussed infra. In this situation, a segment reference stored in the available segment unit 360 is included as a portion of an access address 340 generated by an address unit 393 included in one alternative example embodiment of a memory control unit 310. The address unit 393 receives a segment identifier 390 and also includes an offset counter 395, which is incremented to form a new access address 340 as a complete burst of data is stored in successive locations in an external memory resource 330. It should be appreciated that the segment identifier 390 portion of the address unit 393 makes up a higher order portion of an access address 340. In this situation, the address unit 393 also includes an offset counter 395 which is sized according to the size of a memory segment (e.g. 256 bytes). Again, any size of memory segment can be accommodated and any examples presented herein are for purposes of illustration only and are not intended to limit the scope of the claims appended hereto.

In one alternative example embodiment, a memory control unit 310 includes one or more logical channel units (365, 367,370). A logical channel unit 365, which according to one alternative embodiment, comprises a first-in-first-out (FIFO) memory device. The logical channel unit 365 is used to store a reference to an available segment of memory received from the available segment unit 360. When a reference to an available segment is provided by the available segment unit 360, the logical channel unit 365 captures the reference and also directs the captured reference to a segment identifier 390 portion of the address unit 393. The segment identifier portion 390 of the address unit then uses the segment reference in conjunction with a counter 395 to generate an access address 340 as the receive burst unit 305 stores a complete burst of data in successive location in an external memory resource 330. It should be appreciated that where a particular complete burst of data is larger than a particular memory segment, an additional segment reference is provided by the available segment unit 360 and directed to the logical channel unit 365. The logical channel unit 365 makes the second memory segment reference available to the segment identifier portion 390 of the address unit 393. In this manner, a complete burst of data is allowed to span a plurality of memory segments stored in an external memory resource 330.

In operation, an ingress request decoder 380 included in one alternative example embodiment of a memory control unit 310 receives a logical channel identifier 350 from the receive burst unit 305. The ingress request decoder 380 then selects a particular logical channel unit 365 according to the logical channel identifier 350 received from the receive burst unit 305. The ingress request decoder 380 also generates a grant signal back to the receive burst unit 305, which indicates to the receive burst unit 305 that it is able to store a complete burst of memory in an external memory resource 330.

FIG. 13 further illustrates that, according to one alternative example embodiment, the transmit burst unit 315 comprises a forward back pressure input which is capable of receiving a forward back pressure indicator 317 from an egress interface 325. The transmit burst unit 315 will forego a transfer of a complete burst of egress data to the egress interface 325 when the forward back pressure indicator 317 is active.

It should be appreciated that various alternative example embodiments of a memory control unit 310 include one or more burst information pointers (366,368, 371). Typically, a burst information pointer is associated with the particular logical channel unit (365,367,370). The burst information pointer is used to access a segment in an external memory resource 330 that is used to store egress burst information for a particular logical channel. Accordingly, various alternative example embodiments of a burst data interface controller 320 will use the contents of the burst information pointer to enable the transmit burst unit 315 to retrieve an egress burst information from an external memory resource 330.

In one alternative example embodiment, for example, the transmit burst unit 315 retrieves from an external memory resource 330 egress burst information according to a memory access address 340 provided by the memory control unit. A special burst information request signal 311 is used by the transmit burst unit 315 to distinguish a request signal 355 that is otherwise conveyed from the transmit burst unit 315 to the memory control unit 310 when the transmit burst unit 315 needs to retrieve burst data from an external memory 330.

FIG. 14 further illustrates that, according to one alternative example embodiment, the memory control unit 310 further includes an egress logical channel decoder 385. The egress logical channel decoder 385 receives a logical channel identifier from the transmit burst unit 315. The egress logical channel decoder 385 then selects a particular logical channel unit (365, 367,370) from amongst one or more such logical channel units included in any particular embodiment of a memory control unit 310. A reference to a memory segment is retrieved from the logical channel unit and directed to the segment identifier portion 390 of the address unit 393. The address unit 393 then generates a memory access address 340 according to the segment identifier retrieved from a particular logical channel unit 370 and also according to an offset counter 395 included in the address unit 393. This enables the transmit burst unit 315 to retrieve burst data from the memory according to a logical channel association. It should also be appreciated that the address unit 393, according to one alternative example embodiment, generates successive memory addresses so as to enable retrieval of any one of a complete burst of data and a portion of a complete burst of data.

In one alternative example embodiment, the transmit burst unit 315 retrieves a portion of a complete data packet from an external memory resource 330 by directing a request 355 to the memory control unit 310. The memory control unit 310 then generates a memory access address 340, which is used by the transmit burst unit 315 to access a portion of an egress burst of data stored in an external memory resource 330 using the read interface 345 included in the memory interface 347 provided by the burst data interface controller 320. It should be appreciated that once a memory segment referenced by a segment reference stored in a logical channel unit 370 is exhausted (i.e. all of the data has been retrieved by the transmit burst unit 315), the segment reference stored in the logical channel unit is returned back to the available segment unit 360. This frees the memory segment and allows it to be allocated to a different logical channel unit at a subsequent point in time. It should also be appreciated that a segment reference will not be returned to the available segment unit 360 until all of the data stored in the memory segment is retrieved from the external memory resource 330.

In one alternative example embodiment, the memory control unit 310 provides one or more memory access addresses 340 so as to enable the transmit burst unit 315 to retrieve a complete burst of data from an external memory resource 330. In yet another alternative example embodiment, a memory control unit 310 provides a first set of one or more memory access addresses 340 in order to enable the transmit burst unit 315 to either retrieve a portion of a second complete burst of data stored in the external memory 330 or to retrieve a second complete burst of data stored in the external memory 330.

In all of these example embodiments, the transmit burst unit 315 generates an egress burst of data according to egress burst information retrieved from the memory 330 and further according to burst data retrieved from the memory 330 as heretofore described. The transmit burst unit 315 then directs the egress burst of data to an egress interface 325.

FIG. 13 further illustrates that, according to yet another alternative example embodiment, the burst data interface controller 320 further comprises a memory resource 330 that supports the storage of burst data as heretofore described. In yet another alternative example embodiment, the burst data interface controller 320 further comprises a memory resource 330, an ingress interface 300 and an egress interface 325. In this alternative example embodiment, the ingress interface receives a complete burst of data from a source network and delivers the complete burst of data to the burst receive unit 305. The burst receive unit then stores the complete burst of data in the memory 330 according to the teachings already presented. The memory 330, which is included in this alternative example embodiment, provides the burst data to the transmit burst unit 315, which then directs the burst data to the egress interface 325 of this alternative example embodiment. The egress interface 325 conveys the burst of data to a destination network.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents.

What is claimed is:

1. A method for processing a complete burst of data comprising:
receiving a complete burst of data;
storing the complete burst of data in a memory;
associating the complete burst of data with a first logical channel; and
dispatching an egress burst of data according to one or more complete bursts of data stored in the memory and associated with the first logical channel.

2. The method of claim 1 wherein storing the complete burst of data in a memory comprises:
storing a complete data burst in the memory; and
generating a reverse backpressure indication according to the availability of memory.

3. The method of claim 1 wherein storing the complete burst of data in a memory comprises:
allocating a first segment of the memory; and
storing a first complete burst of data in the first segment of the memory.

4. The method of claim 3 wherein allocating a first segment of memory comprises allocating a quanta of memory according to an egress burst size.

5. The method of claim 1 wherein storing the complete burst of data in a memory comprises:
allocating a first segment of the memory; and
storing a first portion of the complete burst of data in the first segment of the memory and also allocating a second segment of the memory and also
storing a further portion of the complete burst of data in the second segment of the memory when the complete burst of data cannot be accommodated in the first segment of the memory.

6. The method of claim 1 wherein associating the complete burst of data with a first logical channel comprises:
determining a reference to the complete burst of data stored in the memory;
storing the reference in association with a logical channel identifier when no other references are associated with the logical channel identifier; and
storing the reference in association with one or more other references associated with a logical channel identifier when there are references associated with the logical channel identifier.

7. The method of claim 1 wherein dispatching an egress burst of data comprises:
receiving a forward backpressure signal; and
directing an egress burst according to the forward backpressure signal.

8. The method of claim 1 wherein dispatching an egress burst of data comprises:
fetching from the memory a portion of a complete data burst;
associating egress burst information with the fetched portion of the complete data burst; and
directing the fetched portion and the associated egress burst information to an output interface.

9. The method of claim 1 wherein dispatching an egress burst of data comprises:
fetching from the memory a complete data burst;
associating egress burst information with the fetched complete data burst; and
directing the fetched complete data burst and the associated egress burst information to an output interface.

10. The method of claim 1 wherein dispatching an egress burst of data comprises:
fetching from the memory a first complete data burst and at least one of a second complete data burst and a portion of a second complete data burst;
associating egress burst information with the fetched complete data burst and the at least one of a second complete data burst and a portion of a second complete data burst; and
directing the fetched complete data burst and the at least one of a second complete data burst and a portion of a second complete data burst and the associated egress burst information to an output interface.

11. A system for processing a complete burst of data comprising:
ingress interface capable of receiving a complete burst of data;
egress interface capable of transmitting a complete burst of data;
processor capable of executing an instruction sequence;
memory capable of storing an instruction sequence and at least one of a portion of a complete burst of data and a complete burst of data;
one or more instruction sequences stored in the memory including:
burst receiver module that, when executed by the processor, minimally causes the processor to:
receive a complete burst of data from the ingress interface; and
store the complete burst of data in the memory in association with a first logical channel;
burst dispatch module that, when executed by the processor, minimally causes the processor to:
retrieve from the memory one or more complete bursts of data;
generate an egress burst of data according to the retrieved one or more bursts of data; and
direct the egress burst of data to the egress interface.

12. The system of claim 11 wherein the burst receiver module further minimally causes the processor to:
monitor the availability of memory; and
generate a backpressure signal for the ingress interface when the amount of memory falls below a pre-established threshold.

13. The system of claim 11 wherein the burst receiver module causes the processor to store a complete burst of data in the memory by minimally causing the processor to:
allocate a first segment in the memory; and
store a first complete burst of data in the allocated first segment.

14. The system of claim 13 wherein the burst receiver module causes the processor to allocate a first segment in the memory by minimally causing the processor to:
receive an egress burst size indicator from at least one of a memory location and the egress interface; and
allocate a first segment in the memory according to the egress burst size indicator.

15. The system of claim 11 wherein the burst receiver module causes the processor to store a complete burst of data in the memory by minimally causing the processor to:
allocate a first segment in the memory;
store a first portion of a complete burst of data in the first allocated segment;
allocate a second segment in the memory; and
store a further portion of the complete burst of data in the second segment.

16. The system of claim 11 wherein the burst receiver module causes the processor to store a complete burst of data in the memory by minimally causing the processor to:
allocate a burst buffer in the memory;
determine a reference to the burst buffer; and
store the reference in a logical channel table.

17. The system of claim 11 wherein the burst dispatch module causes the processor to dispatch an egress burst of data by minimally causing the processor to:
receive a forward backpressure signal from the egress interface; and
direct an egress burst of data from the memory when the forward backpressure indicator indicates that the egress interface can receive a complete burst of egress data.

18. The system of claim 11 wherein the burst dispatch module causes the processor to dispatch an egress burst of data by minimally causing the processor to:
fetch from the memory a portion of a complete burst of data;
fetch egress burst information from the memory;
generate an egress data burst according to the fetched portion of a complete burst of data and also according to the fetched egress burst information; and
direct the egress data burst to the egress interface.

19. The system of claim 11 wherein the burst dispatch module causes the processor to dispatch an egress burst of data by minimally causing the processor to:
fetch from the memory a complete burst of data;
fetch egress burst information from the memory;
generate an egress data burst according to the fetched complete burst of data and also according to the fetched egress burst information; and
direct the egress data burst to the egress interface.

20. The system of claim 11 wherein the burst dispatch module causes the processor to dispatch an egress burst of data by minimally causing the processor to:
fetch from the memory a first complete burst of data and at least one of a second complete burst of data and a portion of a second complete burst of data;
fetch egress burst information from the memory;
generate an egress data burst according to the fetched first complete burst of data and also according to at least one of the fetched second complete burst of data and the fetched portion of a second complete burst of data and also according to the fetched egress burst information; and
direct the egress data burst to the egress interface.

21. A burst data interface controller comprising:
memory interface capable of interacting with a memory;
burst receive unit capable of receiving a complete burst of data from an ingress interface;
memory control unit capable of enabling the receive burst unit to store a complete burst of data in a memory using the memory interface according to a logical channel association; and
transmit burst unit capable of retrieving one or more bursts of data from a memory using the memory interface and further capable of directing the one or more bursts of data to an egress interface.

22. The burst data interface controller of claim 21 wherein the memory control unit is further capable of generating a backpressure indicator according to an availability of memory.

23. The burst data interface controller of claim 21 wherein the memory control unit comprises an available segment unit capable of providing a reference to a segment in a memory and further comprising an address unit capable of generating successive memory access addresses according to the segment reference when the burst receive unit stores a complete burst of data in a memory.

24. The burst data interface controller of claim 21 wherein the memory control unit comprises an available segment unit wherein a segment reference stored in the available segment unit references a memory segment that is sized according to an egress burst size.

25. The burst data interface controller of claim 21 wherein the memory control unit comprises an available segment unit capable of providing two segment references in response to a request to store a complete burst of data received from the burst receive unit.

26. The burst data interface controller of claim 21 wherein the memory control unit comprises one or more logical channel tables each capable of storing a chain of segment references provided by an available segment unit and further comprising a request decoder capable of selecting a logical channel table according to a request received from the receive burst unit and wherein the available segment unit provides a segment reference to a selected logical channel table in response to a request to store a complete burst of data received from the burst receive unit.

27. The burst data interface controller of claim 21 wherein the transmit burst unit comprises a forward backpressure input that, when activated, causes the transmit burst unit to throttle delivery of a complete burst of data to an egress interface.

28. The burst data interface controller of claim 21 wherein the memory control unit responds to a egress burst information request signal received from the transmit burst unit by providing a memory address to an egress burst information packet stored in a memory and wherein the memory control unit responds to a burst data request received from the transmit burst unit by providing one or more memory addresses for a portion of a complete burst of data stored in a memory.

29. The burst data interface controller of claim 21 wherein the memory control unit responds to a egress burst information request signal received from the transmit burst unit by providing a memory address to an egress burst information packet stored in a memory and wherein the memory control unit responds to a burst data request received from the transmit burst unit by providing a set of memory addresses for a complete burst of data stored in a memory.

30. The burst data interface controller of claim 21 wherein the memory control unit responds to a egress burst information request signal received from the transmit burst unit by providing a memory address to an egress burst information packet stored in a memory and wherein the memory control unit responds to a burst data request received from the transmit burst unit by providing a first set of memory addresses for a complete burst of data stored in a memory and a second set of one or more memory address for a portion of a second complete burst of data stored in a memory.

31. The burst data interface controller of claim 21 further comprising:
memory capable of storing burst data by means of the memory interface.

32. The burst data interface controller of claim 21 further comprising:
memory capable of storing burst data;
ingress interface capable of receiving a complete burst of data form a source network and directing it to the receive burst unit; and
egress interface capable of conveying to an egress network a complete burst of data retrieved from the memory by the transmit burst unit.
